(19) United States
(12) Patent Application Publication
(10) Pub. No.: US 2005/0105777 A1
(43) Pub. Date: May 19, 2005

(54) Personalized multimedia summary

(76) Inventors: William John Kozlowski JR., Juneau, AK (US); Bret Tyson Connell, Juneau, AK (US)

Correspondence Address: SOCAL IP LAW GROUP, 310 N. WESTLAKE BLVD. STE 120, WESTLAKE VILLAGE, CA, 91362, US

(21) Appl. No.: 10/717,234

(22) Filed: Nov. 18, 2003

(51) Int. Cl. H04N 7/173; G06K 9/00

(52) U.S. Cl. 382/115; 725/100

(57) ABSTRACT

There is disclosed methods of creating a presentation of and presenting the abilities of and requirements of a person. A method may include capturing a subject video sequence of a subject person and editing it. An observer video sequence may be captured and edited. A text portion concerning the subject person may be prepared. A subject summary screen that includes links to the edited subject video sequence, the edited observer video sequence, and the text portions may be created. A method may include presenting an opening screen having a plurality of hypertext links. A selected video item may be presented when a video item link is selected, and a selected text item may be presented when a text item link is selected. The selected text item may concern the subject person, and the selected video item may concern and show the subject person or another person.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field Of The Invention

The invention relates to preparing and providing a personalized multimedia summary.

2. Description of Related Art

Persons having physical, medical or emotional conditions, challenges, and/or disabilities may find it difficult to find a job and to transition between different caregivers.

Many potential employers may not understand the capabilities and skills of persons having physical, medical or emotional conditions, challenges, and/or disabilities. Many potential employers may not understand how to provide reasonable accommodations to such persons. This information is typically provided in paper form in a resume, case history, or other documents.

When starting a relationship with a new care provider, persons having physical, medical or emotional conditions, challenges, and/or disabilities, or their current caregiver, parent, spouse, guardian, may be required to educate and instruct the new caregiver about the daily routines, medications, therapies, food preferences, warning signs, medical condition, physical challenges, emotional issues, skills, and abilities of the person under care. This information is typically provided in paper form as written instructions, a case history, or other documents.

### DESCRIPTION OF THE DRAWINGS

FIG. 1 is a block diagram of an environment for creating and displaying a personalized multimedia summary in accordance with the invention.

FIG. 2 is a flow chart of a method of creating a personalized multimedia summary in accordance with the invention.

FIG. 3 is a flow chart of a method of using a personalized multimedia summary in accordance with the invention.

FIG. 4 is a screen shot of a main window of a personalized multimedia summary directed to prospective employers in accordance with the invention.

FIG. 5 is a screen shot of a second main window of a personalized multimedia summary directed to prospective employers in accordance with the invention.

FIG. 6 is a screen shot of a medical description text page included in a personalized multimedia summary in accordance with the invention.

FIG. 7 is a screen shot of a video window of a personalized multimedia summary in accordance with the invention.

FIG. 8 is a screen shot of an emergency information text page included in a personalized multimedia summary in accordance with the invention.

FIG. 9 is a screen shot of a work skills video window of a personalized multimedia summary in accordance with the invention.

FIG. 10 is a screen shot of a routines text page included in a personalized multimedia summary in accordance with the invention.

FIG. 11 is a screen shot of a morning routine text page included in a personalized multimedia summary in accordance with the invention.

FIG. 12 is a screen shot of a transportation text page included in a personalized multimedia summary in accordance with the invention.

FIG. 13 is a screen shot of a warning signs mixed text and video page included in a personalized multimedia summary in accordance with the invention.

FIG. 14 is a screen shot of a sign language page included in a personalized multimedia summary in accordance with the invention.

Throughout this description, the embodiments and examples shown should be considered as exemplars, rather than limitations on the invention.

A System

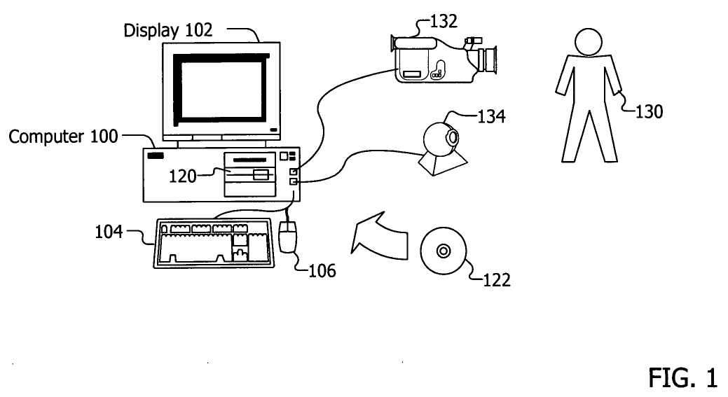

FIG. 1 is a block diagram of an environment for creating and displaying a personalized multimedia summary in accordance with the invention. A personal computer 100 may have coupled thereto a display 102 and user input devices such as a keyboard 104, a mouse 106, a trackball, a pen and table, a touch screen, a touch pad, and others. Video camera 132 is shown coupled to personal computer 100 and webcam 134 is shown coupled to personal computer 100. Video cameras and webcams may be used to capture video and audio. Digital still cameras and microphones (not shown) may also be coupled with personal computer 100 to capture and/or download still images and audio. Video cameras, webcams, microphones and other devices used for capturing images, video, and audio are referred to herein as media capturing devices.

The media capturing devices may be used to capture video and/or audio of a subject person 130 and of an observer. As used herein, an observer is a person familiar with the subject person. As used herein, a subject person is typically a person with a medical condition, physical condition or emotional condition that may require special care and/or accommodations in a place of work, a school, a residence, and other locales and situations.

The media capturing devices may be coupled to the personal computer 100 or a portable computing device when capturing images, video and audio, or may later be attached after capturing to download captured images, audio and video from the media capturing devices to the personal computer 100.

The personalized multimedia summary may be prepared and viewed on a personal computer 100 or other computing device. Although shown implemented in a personal computer, the invention may be implemented with various computing devices. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers.

The computing devices, including personal computer 100, may run an operating system, including, for example, variations of the Linux, Unix, MS-DOS, Microsoft Windows, Palm OS, and Apple Mac OS X operating systems. The computing devices, including personal computer 100, may execute locally or remotely accessible media capturing, editing and playback software. Examples of media playback software include RealPlayer, Flash player or plug-in, Microsoft MediaPlayer and QuickTime from Apple Computer. The computing devices, including personal computer 100, may also execute locally or remotely accessible multimedia presentation creation software such as, for example, Microsoft FrontPage and Macromedia Flash MX, and multimedia presentation software such as, for example, web browsers or other software that is capable of presenting hypertext and multimedia files, including Microsoft Internet Explorer and Netscape Navigator. The multimedia presentation creation software and multimedia presentation software may provide support for the hyper-text markup language (HTML), Macromedia Flash, and others.

The invention may be embodied in whole or in part in software which operates on the personal computer 100 and may be in the form of one or more HTML files and associated text and media files, application programs, stand-alone executables (e.g., Flash projectors) applets (e.g., a Java applet, Flash program), browser plug-ins, COM objects, dynamic linked libraries (DLLs), scripts, subroutines, and others. The hardware and software of the invention and its functions may be distributed such that some components are performed by the personal computer 100 and others by other devices local or remote to the personal computer 100.

The software that implements the techniques described herein may be stored locally on a machine readable medium and/or may be available locally or remotely.

Personal computer 100 includes a compact disk read/write drive (CDRW) 120 or other storage device. Although the techniques discussed herein are described with regard to a compact disk 122, the techniques may be implemented with any machine readable media included with or otherwise coupled with, attached to or accessible by a computing device directly or via a storage device. The storage device and/or machine readable media may be local or remote to the personal computer 100. The machine readable media include, for example, magnetic media such as hard disks, floppy disks and tape; optical media such as compact disks (CD-ROM and CD-RW) and digital versatile disks (DVD and DVD+RW); flash memory cards; chip based devices such as flash memory, electronically erasable programmable read-only memory (EEPROM) devices; and other machine readable media. As used herein, a storage device is a device that allows for reading and/or writing to a machine readable medium. Storage devices include, hard disk drives, DVD drives, flash memory devices, flash memory card readers, and others.

The media capture devices such as video camera 132 and webcam 134 as well as externally coupled storage devices may be coupled with and accessible by personal computer 100 via wired and wireless data transfer techniques such as parallel communications including IEEE 1394 (also known as Firewire and i.link), serial communications including Universal Serial Bus (USB), Ethernet, and via wireless communications such as WiFi and Bluetooth.

In addition, personal computer 100 may be augmented by or include a network interface card (NIC) or device that allows the computer to communicate over a network to and with other computers and computing devices. A network may be a local area network (LAN), a wide area network (WAN), a storage area network (SAN), or a combination of these. The network may be wired, wireless, or a combination of these. The network may include or be the Internet. The network may be public or private. The network may be comprised of numerous nodes providing numerous physical and logical paths for data to travel. A user may create a personalized multimedia summary on personal computer 100 and may store it to a server via a network for access by caregivers, employers, and others via the network, such as, for example, a website. Similarly, a user may create a personalized multimedia summary on personal computer 100 and send it by electronic mail over a network to caregivers, employers and others.

Methods

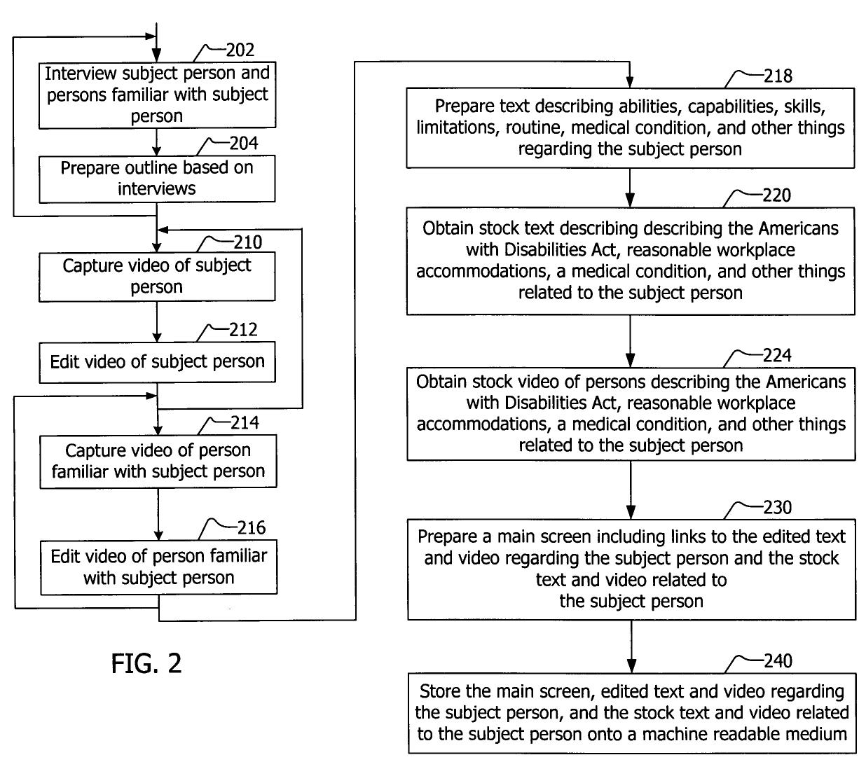

FIG. 2 is a flow chart of a method of creating a personalized multimedia summary in accordance with the invention. To create a personalized multimedia summary, a template may be used to obtain information from the subject person and persons familiar with the subject person in interviews, as shown in block 202. The template may be a listing of categories of information that is typically provided in a personal multimedia summary, including, for example, work abilities and skills, work experience, schooling, parents, spouse, friends, sibling, vocational training, vocational counselor, psychological counselor, medical condition, physical limitations, medications, treatment regimen, medical procedures, favorite foods, favorite activities, favorite television programs, favorite sports, favorite projects and assignments, workplace accommodations needed, emergency information, resources for further information, and others. An outline of a personalized multimedia summary may be prepared based on the interviews, as shown in block 204.

Video of a subject person is captured, as shown in block 210. Video may be captured of the subject person going about his or her day to day activities, working, playing, getting dressed, eating, applying medications, and/or receiving medications, medical attention, therapy, and others. The video may be captured at the subject person's home, place of work, caregiver's office, and other locations. The video sequence captured of the subject person may be prompted by an interviewer asking the subject person questions. The number of video sequences captured, the length of the video sequences captured, and the themes of the video sequences captured may be dependent on the physical, medical or emotional conditions, challenges, and disabilities of the subject person.

The video sequences may be captured by a hand held video camera, a webcam, or a camera equipped device, such as a portable telephone, portable computer, personal digital assistant, and others.

The video sequences may be captured and concurrently stored on or later downloaded to a personal computer where the video sequences may be edited, as shown in block 212. Editing may include paring the video sequences to show only the most pertinent characteristics of the subject person. Editing may also include augmenting the video sequence with text, graphics and/or audio that in some way corresponds to or enhances the content of the video sequences. For example, an audio augmentation may be a parent or caregiver speaking of how the subject person gets dressed, applies medication or eats while the video sequence shows the subject person performing these activities, namely getting dressed, applying medication and eating. Another example is an employer or vocational counselor explaining the work place abilities and skills of the subject person while the subject person is shown in the video sequence performing those skills.

Audio may be obtained by inviting a caregiver, parent, employer, counselor or other person to speak into a microphone attached to a computer or other computing device while the video sequence is being viewed or independent of viewing the video sequence. Audio may also be obtained by recording a caregiver, parent, employer, counselor or other person at a location with a portable tape recorder, computer or other computing device. The audio may be transferred to the personal computer for editing, and, in some instances, may be combined with video, still images, and/or graphics.

Video of a person familiar with the subject person may be captured, as shown in block 214. The audio from a video sequence of a person familiar with the subject person may be used to augment a video sequence of the subject person. As above, the capturing may occur in a convenient location, and may be prompted by an interviewer asking questions. The video sequences of persons familiar with the subject person may be edited, as shown in block 216. While editing, the most pertinent portions of the video sequences may be retained, and the video sequence may be augmented with text, graphics, and audio, as discussed above.

Text may be prepared describing the abilities, capabilities, skills, limitations, routines, medical condition, and other things regarding the subject person, as shown in block 218.

When creating a personalized multimedia summary for the first time, general text descriptions of the Americans with Disabilities Act, reasonable workplace accommodations, medical conditions, and other information may be prepared. These descriptions may be used in preparing personalized multimedia summaries for multiple subject persons. For example, a description of a medical condition (e.g., von Willebrands) shared by multiple subject persons may be included in the personalized multimedia summaries for each of these subject persons. These descriptions are reusable and may be included in a directory or other repository of stock text. Stock text describing the Americans with Disabilities Act, reasonable workplace accommodations, a medical condition, and other things related to the subject person may be obtained, as shown in block 220.

When creating a personalized ability summary for the first time, video sequences of medical personnel, counselors, and others providing general descriptions of the Americans with Disabilities Act, reasonable workplace accommodations, medical conditions, and other information may be recorded. These video sequences may be used in preparing personalized multimedia summaries for multiple subject persons. For example, a video sequence of a description of a medical condition (e.g., von Willebrands) shared by multiple subject persons may be included in the personalized multimedia summaries for each of these subject persons. These video sequences are reusable and may be included in a directory or other repository of stock video sequences. Stock video of persons describing the Americans with Disabilities Act, reasonable workplace accommodations, a medical condition, and other things related to the subject person may be obtained, as shown in block 224.

A main window including links to the edited text and video regarding the subject person and the stock text and video related to the subject person may be prepared and stored as a main window control file, as shown in block 230. The main window control file may be an HTML document and may be created with an HTML editor, a web page creation software product, and other software tools that allow for the creation and storage of a main window control file. The main window control file may also be a Flash file. The main window control file, edited text and video regarding the subject person, and the stock text and video related to the subject person may be stored on a machine readable medium, as shown in block 240. The main window control file and the main window may pull in and/or have links to each of the edited text and video files regarding the subject person and the stock text and video related to the subject person. The edited text and video regarding the subject person and the stock text and video related to the subject person may be stored locally on a machine readable medium such as a hard disk or a CD, and/or may be accessed from a remote computer or other computing device over a network.

As the video of the subject person discussed regarding block 210, the video of persons familiar with the subject person discussed regarding block 214, and the text describing the abilities, capabilities, etc. regarding the subject person discussed regarding block 218 may contain confidential and private information concerning the subject person, some or all of the information may be protected by a password or other authentication technique when stored on a machine readable medium as discussed regarding claim 240. In this way, a subject person (guardian, caregiver, or other responsible person) may limit access to all or one or more portions of the personalized multimedia summary to those persons who are provided a password.

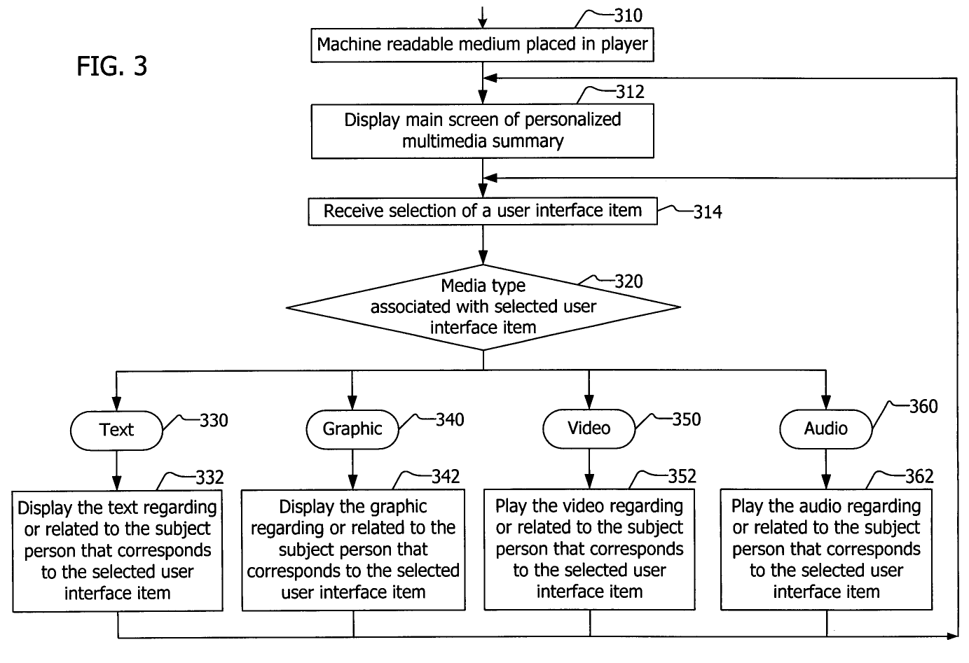

FIG. 3 is a flow chart of a method of using a personalized multimedia summary in accordance with the invention. When the personalized multimedia summary is stored on a portable machine readable medium, such as, for example, a CD or flash memory card, the machine readable medium may be placed in a player, as shown in block 310. Alternatively, a personalized multimedia summary that is stored on a network may be accessed by specifying an Internet web location. A uniform resource locator (URL) or uniform resource identifier (URI) may be used to access a personalized multimedia summary. In this way, a subject person may provide a link to direct desired viewers to an Internet web page.

The main window of the personalized multimedia summary may be automatically displayed, as shown in block 312.

In one embodiment, a viewer is authenticated before being given access to the private and confidential information included in the personalized multimedia summary. Authentication may be achieved by password or other technique. Authentication may occur once at the outset, or may occur prior to viewing private and confidential portions of the personalized multimedia summary.

A user selection of a user interface item displayed on the main window, such as a button or icon having a link, may be received, as shown in block 314. A check is made to determine the media type associated with the selected user interface item, as shown in block 320. If the media type associated with the selected user interface item is text, as shown in block 330, the text portion regarding or relating to the subject person that corresponds to the selected user interface item is displayed, as shown in block 332. This may be achieved in an Internet browser or using a text viewer. A window may be opened in addition to the main window, the text may be displayed in the main window, and the text portion may replace the main window in its entirety. The text may be retrieved from a local machine readable medium, or may be retrieved from a remote device, such as, for example, by following a URL or URI.

If the media type associated with the selected user interface item is a graphic, as shown in block 340, the graphic regarding or relating to the subject person that corresponds to the selected user interface item is displayed, as shown in block 342. This may be achieved with an Internet browser, using a graphics viewer, or other viewing program or plug-in. A window to display the graphic may be opened in addition to the main window, the graphic may be included in or superimposed on the main window, and a graphic screen may replace the main window. The graphic may be retrieved from a local machine readable medium, or may be retrieved from a remote device, such as, for example, by following a URL or URI.

If the media type associated with the selected user interface item is video, as shown in block 350, the video sequence regarding or relating to the subject person that corresponds to the selected user interface item is played, as shown in block 532. This may be achieved by a web browser starting a video player plug-in such that the video sequence is played in the main window. This may also cause a video player to be started such that the video sequence is played in a window adjacent to the main window. The video sequence may be retrieved from a local machine readable medium, or may be retrieved from a remote device, such as, for example, by following a URL or URI.

If the media type associated with the selected user interface item is audio, as shown in block 360, the audio regarding or relating to the subject person that corresponds to the selected user interface item is played, as shown in block 562. This may be achieved by a web browser starting an audio player plug-in such that the audio is played in the main window. This may also cause an audio player to be started such that an audio window independent of the main window is created. The audio may be retrieved from a local machine readable medium, or may be retrieved from a remote device, such as, for example, by following a URL or URI.

Although not shown, a media type associated with a user interface item may be a multimedia item that may involve the display or playing of a multimedia item by a multimedia player or by two or more players in conjunction with one another. A multimedia item may be handled as a video sequence by a video player. If the multimedia item is a Flash program or other multimedia program, a Flash player or other multimedia player may be invoked to play the multimedia item.

Screen Shots

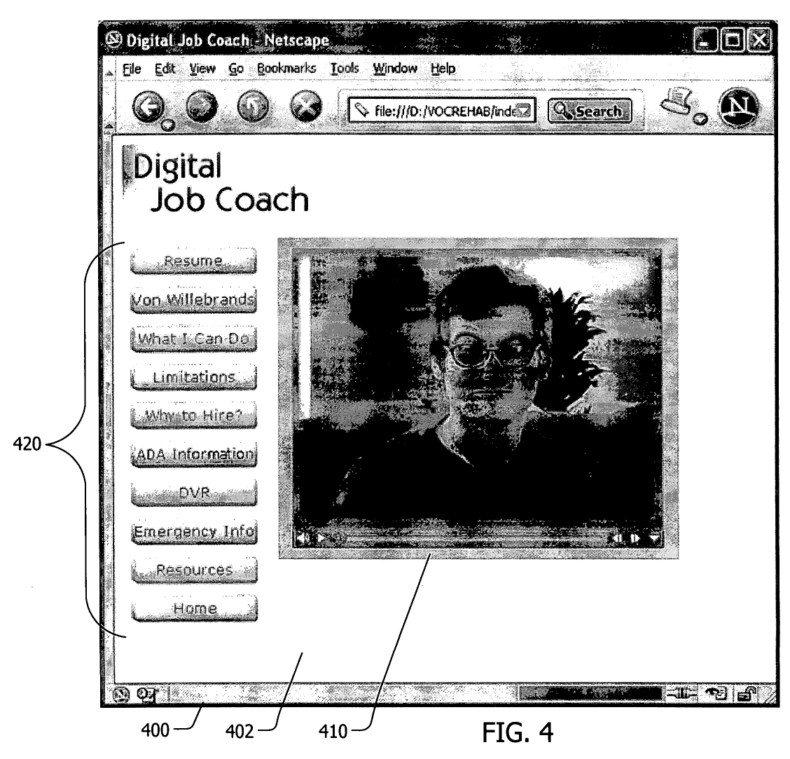

FIG. 4 is a screen shot of a main window of a personalized multimedia summary in accordance with the invention. This example main window 402 is directed to prospective employers. When a CD or other machine readable medium is placed in a drive, a viewer such as an Internet web browser, other HTML viewer, or other viewer may automatically execute and provide a browser window 400 having a main window 402 on a display. The main window 402 may be comprised of multiple sub-windows, frames, and other window constructs, and may include text, graphics, images, and user interface items such as buttons, some of which may have links or hyper-links associated therewith. The main window 402 may include a still photograph of the subject person, may automatically play an audio clip of the subject person giving an introductory message, or may automatically play a video sequence of the subject person giving an introductory message. The still image may be displayed by the browser. The still image may be in a well known or proprietary format, including, for example, JPEG and GIF. The audio clip may be played by a plug-in, media player, or audio player that is activated by the browser or other viewer. The video sequence may be played by a video player, media player, or plug-in that may be started by the browser or other viewer. The video player may cause a video window 410 to be displayed on main window 402.

The main window 402 may include a title of the page such as, for example, DIGITAL JOB COACH, may include the name of the subject person, and may include other biographical or descriptive information about the subject person. The main window may include a series of user interface items such as bars or buttons 420 which, when activated by a user, may cause a text or media item to be displayed. The text or media item to be displayed may correspond to a text label on the buttons 420. Buttons 420 may be any user interface item, including flash animation with active regions, thumbnails, icons, and others. The button 420 or other user interface item may guide a user to clicking on or otherwise activating the user interface item to obtain information concerning the subject specified or suggested by the text, icon, graphic, label or other user interface item or label thereon. The button or other user interface item, when clicked on or otherwise activated by a user, may cause text, text augmented with audio, audio, video, or a combination of these and/or a new web page to be presented to the user either in the current window, in a new window, or both. When a video is displayed it may be of the subject person or another person discussing the subject of the button or other user interface item.

The buttons 420 in this example include (1) resume, (2) a medical condition such as von Willebrands (a blood disorder), (3) work abilities such as “what I can do”, (4) limitations, (5) a presentation by a professional explaining why the subject person should be hired or explaining why a person with disabilities in general or a particular disease can successfully be hired and contribute to the work place, (6) ADA information, (7) DVR (Department of Vocational Rehabilitation), (8) emergency information, and (9) resources for further information concerning the medical condition or disability of the subject person.

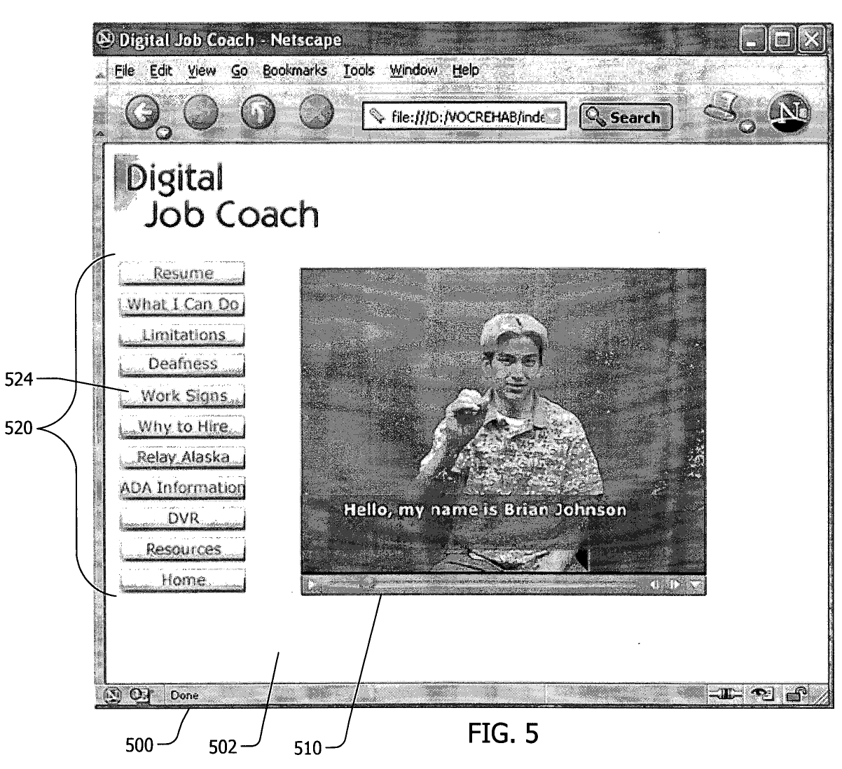

FIG. 5 is a screen shot of a second main window of a personalized multimedia summary in accordance with the invention. This example main window 502 is directed to prospective employers. Browser window 500 displaying main window 502 may include video player window 510. The video sequence may be augmented by text, graphics and other information providing media which together with the subject person provide an introductory message. As shown in this example, the subject person is using sign language to present the introductory message which is accompanied by text.

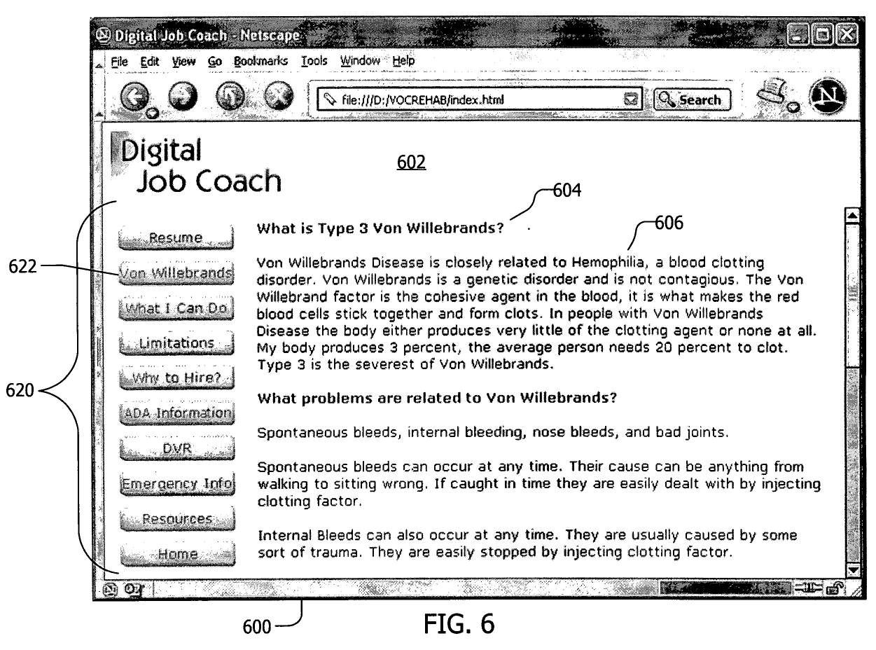

FIG. 6 is a screen shot of a medical description text page included in a personalized multimedia summary in accordance with the invention. In this example, when a user selects button 622 of the buttons 620 on main window 602 in browser window 600, a text item is displayed having one or more headings 602 and descriptive information 604 concerning a medical condition of the subject person. In this example, the medical condition is von Willebrand disease.

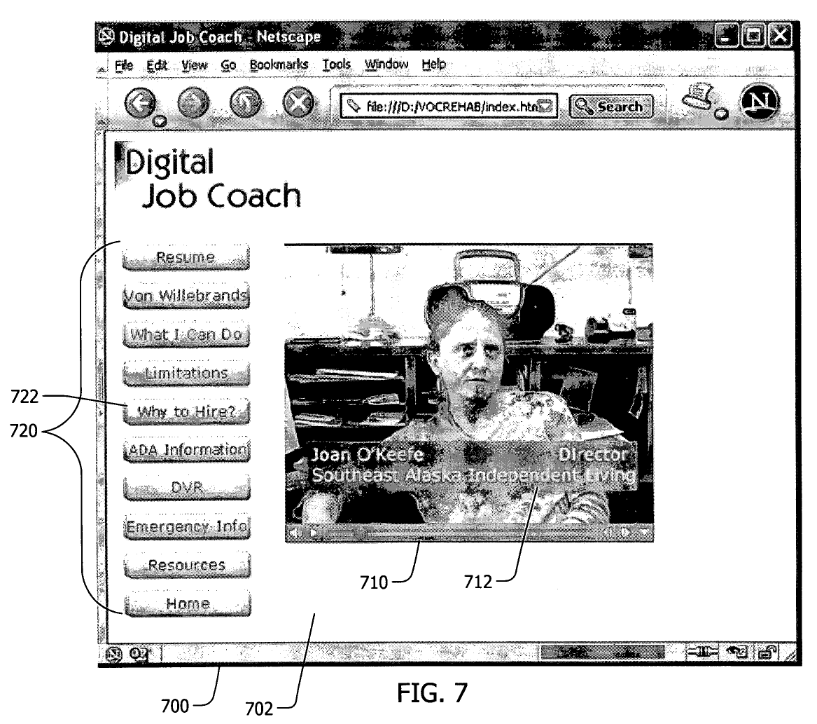

FIG. 7 is a screen shot of a video window 710 of a main window 702 of a personalized multimedia summary in accordance with the invention. This example main windows 702 is directed to prospective employers. In this example, when a user selects button 722 of the buttons 720 on main window 702 in browser window 700, a video sequence is displayed using a video player plug-in in video window 710. The video as depicted is augmented by text describing the person's position. In this example, the video may present a specialist describing in general why a disabled person should be hired, and/or may present a specialist explaining specific characteristics of the subject person and why the subject person should be hired.

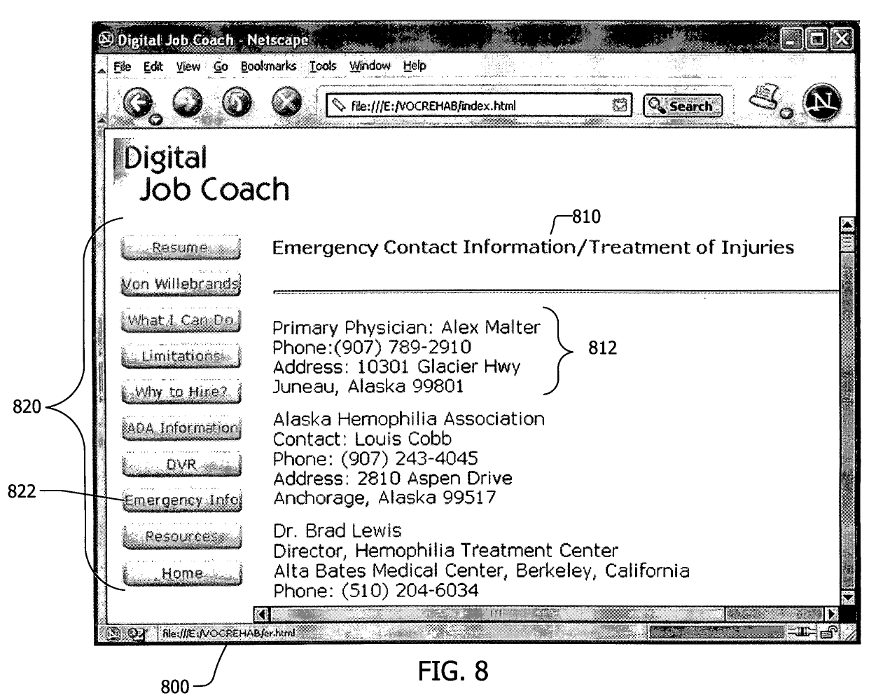

FIG. 8 is a screen shot of an emergency information text page included in a personalized multimedia summary in accordance with the invention. In this example, when a user selects button 822 of the buttons 820 in browser window 800, text is displayed that includes a heading 810 and descriptions 812 including contact information of various persons and/or entities to be contacted in the event of an emergency. The text information may be presented in other formats, including tables, columns, and others.

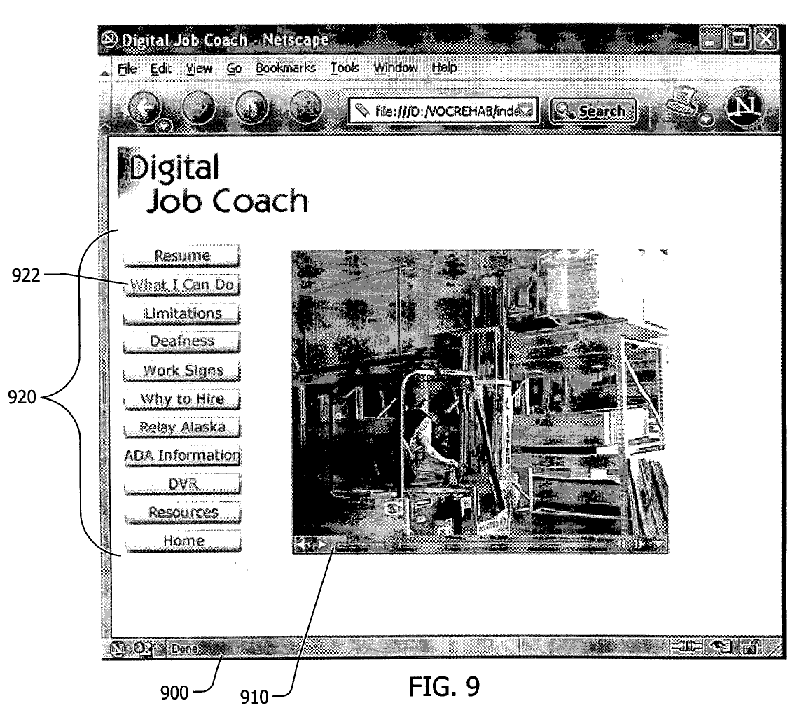

FIG. 9 is a screen shot of a work skills video window of a personalized multimedia summary directed to prospective employers in accordance with the invention. In this example, when a user selects “what I can do” button 922 of the buttons 920 in browser window 900, a video sequence is displayed using a video player plug-in in video window 910. The video in player window 910 shows a subject person using a forklift in a warehouse. The “what I can do” button 922 may also cause text to be presented listing the work capabilities of the subject person, such as stocking shelves, filing, computer diagnostics, change tires, and others. The “what I can do” button 922 may also cause a video sequence to be displayed in which the subject person describes his or her abilities. Text, graphics, and/or video may be combined into a multimedia segment such as a Flash clip, and may be prepared and presented.

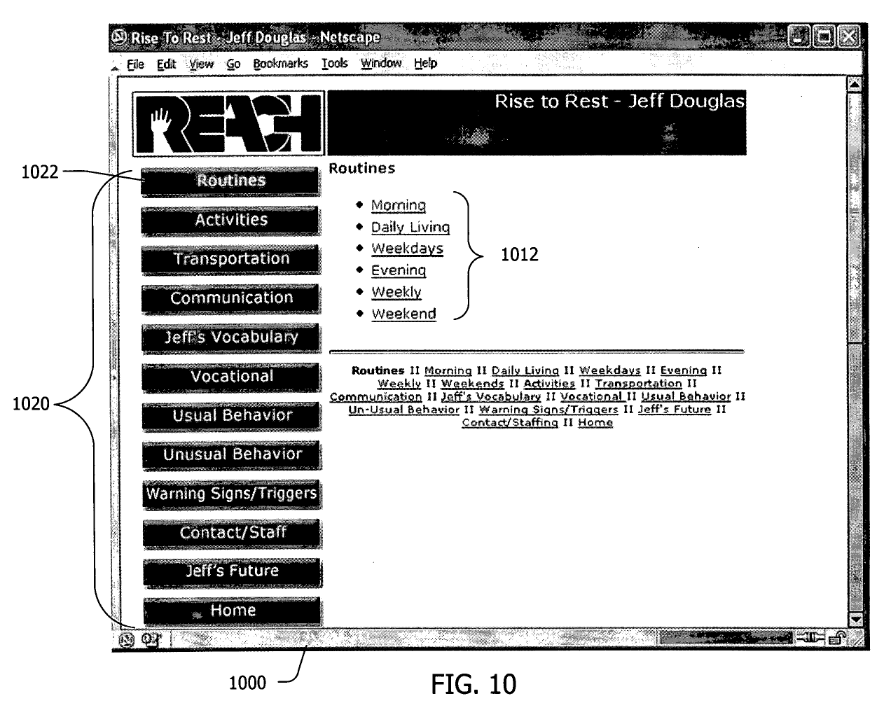

FIG. 10 is a screen shot of a routines text page included in a personalized multimedia summary in accordance with the invention. In this example, when a user selects “routine” button 1022 of the buttons 1020 in browser window 1000, a text listing 1012 is displayed that includes a text linked to further items regarding the subject person's morning routing, dialing living routine, weekday routine, evening routine, weekly routine, and weekend routine. A heading may also be displayed. When any of the hypertext items is selected, further information concerning the selected routine is provided. The further information may be a video of the subject person or other person describing the particular routine, may be the subject person or another person narrating a video of the selected routine, or may be a text description providing information concerning the selected routine.

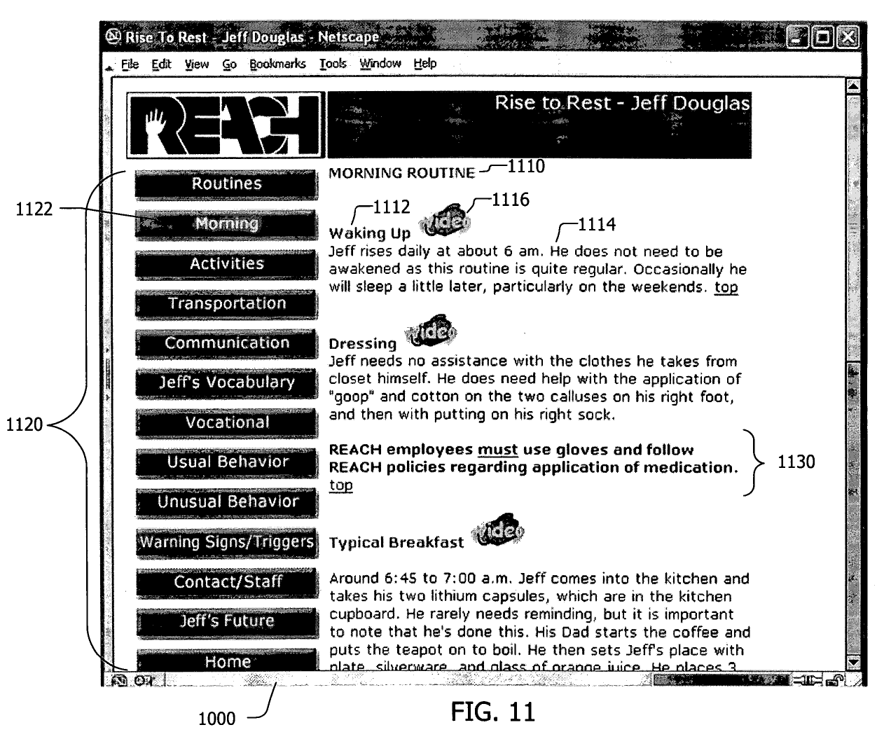

FIG. 11 is a screen shot of a morning routine text page included in a personalized multimedia summary in accordance with the invention. When a routine is selected, the label of “routine” button 1022 of FIG. 10 may change to reflect the user selected routine, morning, as shown by “morning” button 1122 of FIG. 11. When “morning” hypertext of text 1012 is selected in FIG. 10, text augmented with video selections may be presented. The text may include headings 1110 and 1112, textual information about the headings 1114 and icons 1116. The icons 1116 prompt the user to click on or otherwise activate the icon to view a video sequence concerning the activity described in the heading 1112. The video sequence may be of the subject person or other person describing the particular routine, and may be the subject person or another person narrating a video of the subject person performing the selected routine. Warnings, alerts or other special text 1130 may be included. The special text 1130 may be based on the characteristics of the subject person and may include information concerning governmental procedures, institutional requirements, and other similar information.

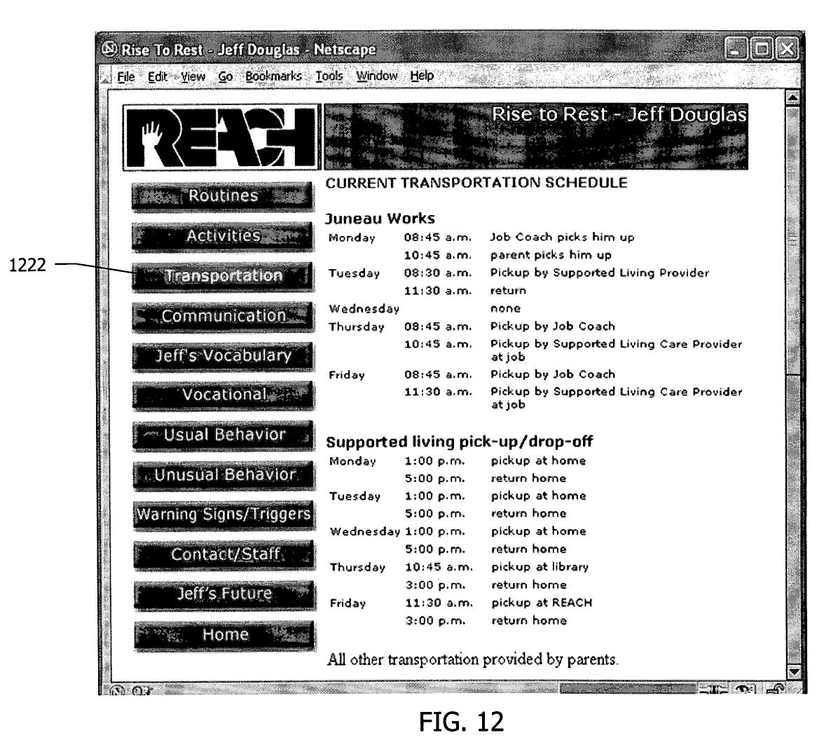

FIG. 12 is a screen shot of a transportation text page included in a personalized multimedia summary in accordance with the invention. In this example, when a user selects “transportation” button 1122, a text listing is displayed that includes transportation responsibilities and times for various transportation providers. The transportation providers may be, for example, care providers, parents, spouses, training organizations, and others. A heading may also be displayed.

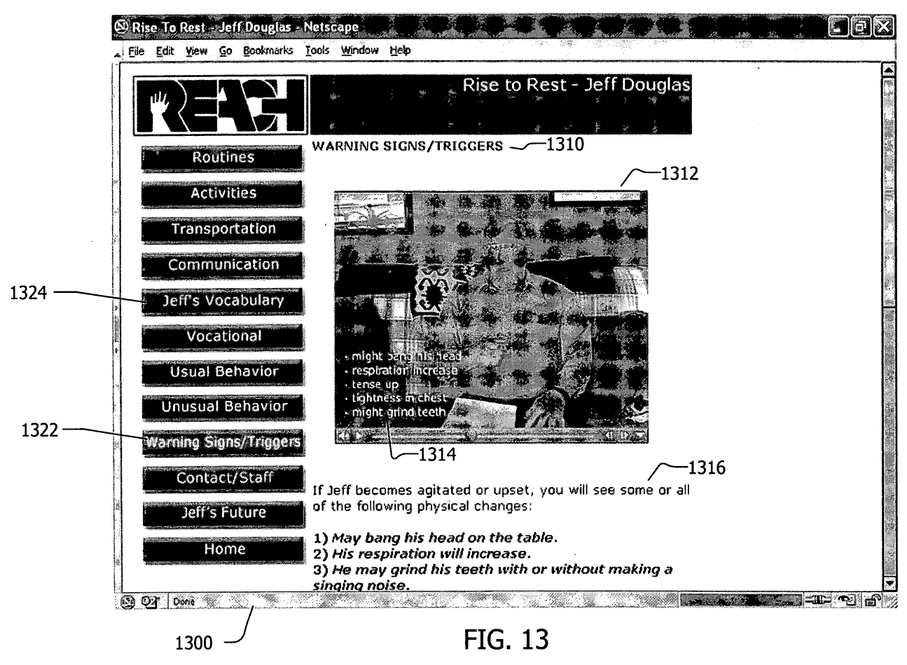

FIG. 13 is a screen shot of a warning signs mixed text and video page included in a personalized multimedia summary in accordance with the invention. In this example, when a user selects “warning signs/triggers” button 1322, a heading 1310 describing the information provided is displayed along with text 1316 and/or video in a video window 1312 describing behavioral, environmental, and/or physical warning signs and triggers. A video sequence of the subject person and/or of another person may be played describing and/or showing the physical agitation or other warning signs and triggers of a subject person. Text 1316 may be superimposed on the video sequence to highlight important information discussed and/or shown in the video sequence.

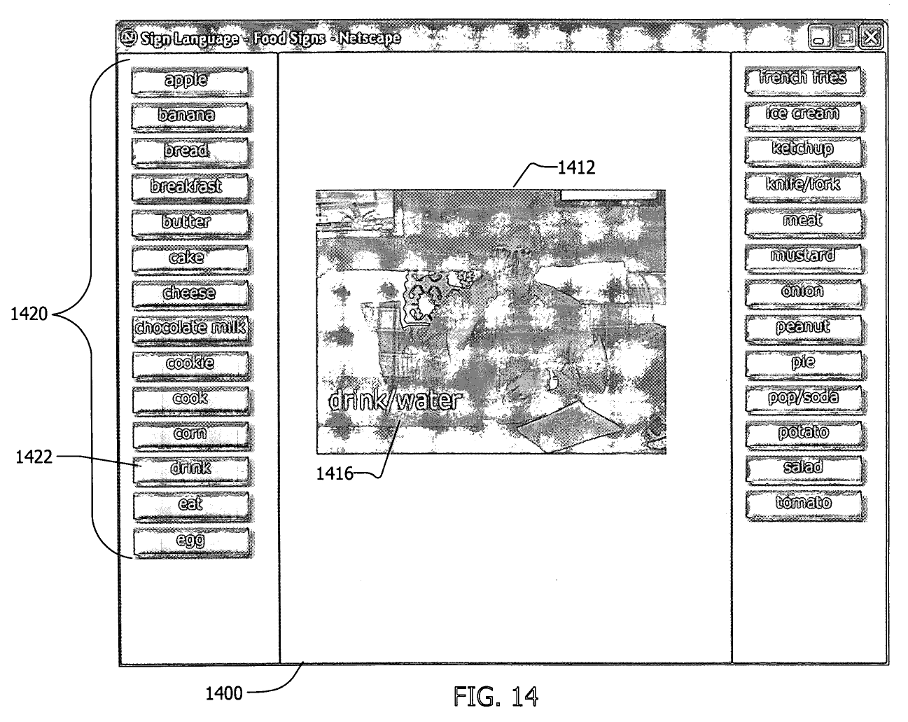

FIG. 14 is a screen shot of a sign language page included in a personalized multimedia summary in accordance with the invention. When “work signs” button 524 in FIG. 5 is selected, a “sign language” page may be presented. Similarly, when viewing the page provided after selecting “vocabulary” button 1324 of FIG. 13, a “sign language” button or hyperlinked text may be selected, and, in response, a “sign language” page may be presented. The sign language page may include or be sign language window 1400. The sign language window 1400 may be displayed in place of or in addition to a prior page or a main window, such as page 500 of FIG. 5. The sign language page may include many buttons 1420 labeled with words that the subject person may either or both know how to recognize or know how to sign. As depicted in FIG. 14, the father of a subject person is showing the sign for drink in response to a user selecting the drink button 1422. A video sequence is played in video window 1412 in which the father shows the sign for water which the subject person can understand. The video sequence may be augmented with textual information 1416 describing the sign being shown. In this way, caregivers, co-workers and others may learn how to communicate information to the subject person.

Similarly, a subject person may be presented in the video window 1412 presenting the signs the subject person knows how to make. In this way, caregivers, co-workers and others may learn how to understand what the subject person is communicating.

Although exemplary embodiments of the present invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

1. A method for creating a presentation of the abilities of and requirements for a person comprising:
capturing at least one subject video sequence of a subject person
editing the subject video sequence to create an edited subject video sequence
capturing an observer video sequence
editing the observer video sequence to create an edited observer video sequence
preparing at least two text portions concerning the subject person
creating a subject summary screen that includes a first link to the edited subject video sequence, a second link to the edited observer video sequence, and hypertext links to the at least two text portions.

2. The method of claim 1 wherein the subject video sequence shows the subject person performing at least one of getting dressed, work place skills, communicating.

3. The method of claim 1 wherein the observer video sequence shows at least one of a caregiver, an employer, a friend, a parent, a spouse, and a medical provider of the subject person.

4. The method of claim 1 wherein the observer video sequence shows an observer discussing at least one of an abilities of the subject person, a medical condition of the subject person, a demeanor of the subject person.

5. The method of claim 1 wherein the text portions include text concerning at least two of daily routines, transportation requirement, communication abilities, medical condition, usual behavior, unusual behavior, and warning signs concerning the subject person.

6. The method of claim 1 further comprising:
storing the subject summary screen, the edited subject video sequence, the edited observer video sequence, and the at least two text portions to a machine readable medium.

7. The method of claim 1 further comprising:
providing the machine readable medium to prospective employers or prospective caregivers when requested to do so by the subject person.

8. The method of claim 1 further comprising:
making the machine readable medium accessible via a network.

9. A method for creating a presentation of the abilities of and requirements of a person comprising:
capturing at least one subject video sequence of a subject person performing at least one of getting dressed, work place skills, communicating
capturing an observer video of at least one of a caregiver, an employer, a friend, a parent, a spouse, and a medical provider of the subject person discussing at least one of an abilities of the subject person, a medical condition of the subject person, a demeanor of the subject person
editing the subject video sequence to create an edited subject video sequence
editing the observer video sequence to create an edited observer video sequence
preparing at least two text portions concerning the subject person, including text concerning at least two of daily routines, transportation requirement, communication abilities, medical condition, usual behavior, unusual behavior, and warning signs
creating a subject summary screen that includes a first link to the edited subject video sequence, a second link to the edited observer video sequence, and hypertext links to the at least two text portions
storing the subject summary screen, the edited subject video sequence, the edited observer video sequence, and the at least two text portions to a machine readable medium.

10. A method of presenting the abilities of and requirements of a person comprising:
presenting an opening screen to a viewer, the opening screen having a plurality of hypertext links, including at least one each of a video item link and a text item link, each of the hypertext links having one of a plurality of graphical user interface items associated therewith
receiving a viewer selection of one of the hypertext links
presenting a selected video item to the viewer when the viewer selection is the video item link, the selected video item presenting at least one of the subject person and an observer of the subject person discussing the subject person
presenting a selected text item to the viewer when the viewer selection is the text item link, the selected text item concerning the subject person.

11. The method of claim 10 wherein the observer is at least one of a caregiver to the subject person, an employer of the subject person, a friend of the subject person, a parent of the subject person, a spouse of the subject person, and a medical provider of the subject person.

12. The method of claim 10 wherein the selected video item has as a subject at least one of an abilities of the subject person, a medical condition of the subject person, a daily routine of the subject person, a demeanor of the subject person.

13. The method of claim 12 wherein the abilities include at least one of work place skills, physical limitations, intelligence, mental capacity.

14. The method of claim 10 wherein the text item describes at least one of an abilities of the subject person, a medical condition of the subject person, a daily routine of the subject person, a demeanor of the subject person.

15. The method of claim 14 wherein the abilities include at least one of work place skills, physical limitations, intelligence, mental capacity.

16. The method of claim 10 wherein the graphical user interface items include a text label, an icon, and a thumbnail image.

17. A machine readable medium having stored thereon instructions which when executed cause a system to perform operations to present the abilities of and requirements of a person comprising:
presenting an opening screen to a viewer, the opening screen having a plurality of hypertext links, including at least one each of a video item link and a text item link, each of the hypertext links having one of a plurality of graphical user interface items associated therewith
receiving a viewer selection of one of the hypertext links
presenting a selected video item to the viewer when the viewer selection is the video item link, the selected video item presenting at least one of the subject person and an observer of the subject person discussing the subject person
presenting a selected text item to the viewer when the viewer selection is the text item link, the selected text item concerning the subject person.

18. The machine readable medium of claim 17 wherein the observer is at least one of a caregiver to the subject person, an employer of the subject person, a friend of the subject person, a parent of the subject person, a spouse of the subject person, and a medical provider of the subject person.

19. The machine readable medium of claim 17 wherein the selected video item has as a subject at least one of an abilities of the subject person, a medical condition of the subject person, a daily routine of the subject person, a demeanor of the subject person.

20. The machine readable medium of claim 19 wherein the abilities include at least one of work place skills, physical limitations, intelligence, mental capacity.

21. The machine readable medium of claim 17 wherein the text item describes at least one of an abilities of the subject person, a medical condition of the subject person, a daily routine of the subject person, a demeanor of the subject person.

22. The machine readable medium of claim 21 wherein the abilities include at least one of work place skills, physical limitations, intelligence, mental capacity.

23. The machine readable medium of claim 17 wherein the graphical user interface items include a text label, an icon, and a thumbnail image.

24. The machine readable medium of claim 17 included in a computing device.

25. The machine readable medium of claim 17 included in a server computing device to be transmitted to a client computing device over a network.

26. A machine readable medium having stored thereon instructions which when executed cause a system to perform operations to present the abilities of and requirements of a person comprising:
presenting an opening screen to a viewer, the opening screen having a plurality of hypertext links, including at least one each of a video item link and a text item link, each of the hypertext links having one of a plurality of graphical user interface items associated therewith
receiving a viewer selection of one of the hypertext links
presenting a selected video item to the viewer when the viewer selection is the video item link, the selected video item presenting one of the subject person, a caregiver to the subject person, an employer of the subject person, a friend of the subject person, a parent of the subject person, a spouse of the subject person, and a medical provider of the subject person discussing at least one of an abilities of the subject person, a medical condition of the subject person, a daily routine of the subject person, a demeanor of the subject person
presenting a selected text item to the viewer when the viewer selection is the text item link, the selected text item describing at least another of the abilities of the subject person, the medical condition of the subject person, the daily routine of the subject person, the demeanor of the subject person.
